(19) United States
(12) Patent Application Publication
(10) Pub. No.: US 2010/0266317 A1
(43) Pub. Date: Oct. 21, 2010

(54) IMAGE FORMING APPARATUS AND IMAGE FORMING METHOD

(75) Inventors: Koichi KAMIJO, Matsumoto-shi (JP); Satoshi CHIBA, Suwa-shi (JP); Shinichi TANAKA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/761,561

(22) Filed: Apr. 16, 2010

(30) Foreign Application Priority Data
Apr. 17, 2009 (JP) 2009-100878

(51) Int. Cl. G03G 15/16

(52) U.S. Cl. 399/316

(57) ABSTRACT

An image forming apparatus includes: an image carrier that carries an image; a transfer roller having a transfer material grip member that moves in a circumferential direction and holds a transfer material, the transfer roller forming a transfer nip portion with the image carrier by coming into contact with each other; and a transfer material feed portion that delivers the transfer material to the transfer nip portion. The transfer material feed velocity of the transfer material feed portion is greater than the movement velocity of the transfer material grip member when the transfer material grip member moves from the rotational center of the transfer roller in the circumferential direction of the transfer roller.

### BACKGROUND

1. Technical Field

The present invention relates to an electrophotographic transfer apparatus, an image forming apparatus, and an image forming method.

2. Related Art

An image forming apparatus provided with a transfer apparatus that visualizes a latent image on an image carrier by developing that latent image using a developing unit and transfers a toner image upon the image carrier directly onto a transfer material such as paper has been proposed. In addition, an image forming apparatus provided with a transfer apparatus that visualizes a latent image on an image carrier by developing that latent image using a developing unit, transfers a toner image upon the image carrier onto an intermediate transfer medium configured of belts stretched across multiple rollers or drums, and then transfers the toner image on the intermediate transfer medium onto a transfer material, has also been proposed.

JP-A-3-004241 discloses an image apparatus in which a latent image upon a photosensitive member serving as an image carrier is developed into a toner image by a developing unit, the image apparatus being provided with a transfer drum that transfers the toner image upon the photosensitive member onto a transfer material. The transfer drum includes a gripper for grip the transfer material, an attraction charging unit that electrostatically attracts the transfer material onto the transfer drum, a transfer charging unit for transferring the toner image upon the photosensitive member onto the transfer material, and a separation charging unit for separating the transfer material onto which the toner image was transferred from the transfer drum.

JP-T-2000-508280 discloses an image forming apparatus provided with a transfer drum, where a toner image is formed by developing a latent image upon a photosensitive member using a liquid developer, the toner image upon the photosensitive member is transferred to an intermediate transfer drum that serves as an intermediate transfer medium, and the transfer drum then transfers the toner image upon the intermediate transfer drum onto a transfer material. The toner image upon the intermediate transfer drum is transferred onto the transfer material by applying heat and pressure. The transfer drum also includes a gripper that holds the transfer material. Furthermore, a separating member that separates the transfer material from the transfer drum is disposed external to the transfer drum.

Incidentally, the image forming apparatus disclosed in JP-A-3-004241 requires multiple charging units, including the stated transfer material attraction charging unit, the transfer charging unit, and the separation charging unit, to be disposed within the transfer drum, leading to a complicated configuration for the apparatus, and also making it difficult to control the positioning of the transfer material. Meanwhile, the image forming apparatus disclosed in JP-T-2000-508280 employs heat transfer, in which the transfer of the toner image onto the transfer material is carried out through the application of heat and pressure, and thus the bond between the transfer material onto which the toner image has been transferred and the transfer drum becomes stronger, making it difficult to separate the transfer material from the transfer drum, and furthermore making it difficult to position the transfer material.

### SUMMARY

An advantage of some aspects of the invention is to provide an image forming apparatus and an image forming method that enable a transfer material to be positioned accurately and improve the transferability of an image upon an image carrier onto a transfer material.

An image forming apparatus according to an aspect of the invention includes an image carrier that carries an image; a transfer roller having a transfer material grip member that moves in a circumferential direction and holds a transfer material, the transfer roller forming a transfer nip portion with the image carrier by coming into contact with each other; and a transfer material feed portion that feeds the transfer material to the transfer nip portion. The transfer material feed velocity of the transfer material feed portion is greater than the movement velocity of the transfer material grip member when the transfer material grip member moves from the rotational center of the transfer roller in the circumferential direction of the transfer roller. The tip portion of the transfer material makes contact with the transfer material positioning portion of the transfer material grip member, and the tip portion thereof flexes due to the velocity difference; this makes it possible to provide a buffer and position the transfer material in a stable manner.

An image forming apparatus according to another aspect of the invention further includes a position detection portion that detects the movement position of the transfer material grip member in the circumferential direction of the transfer roller. This enables the transfer material to be positioned in a more accurate manner.

An image forming apparatus according to another aspect of the invention further includes a control unit that controls the feed timing of the transfer material from the transfer material feed unit based on movement position information of the transfer material grip member detected by the position detection portion. This makes it possible to synchronize the transfer material feed velocity with the transfer material grip member movement velocity in a more accurate manner.

In an image forming apparatus according to another aspect of the invention, the transfer roller includes an indented portion in which the transfer material grip member is disposed and an elastic transfer material support portion that supports the transfer material by making contact with the transfer material. This makes it possible to support the transfer material grip member in a position in which the transfer material grip member will not make contact with the image carrier.

In an image forming apparatus according to another aspect of the invention, the transfer material is caught by the transfer material grip member when the indented portion is positioned at the transfer nip portion. Grip the transfer material at a position in which the indented portion opposes the image carrier makes it possible to hold the transfer material in a stable manner without the influence of fluctuations in velocity caused by contact with the image carrier.

An image forming apparatus according to another aspect of the invention further includes a transfer material transport guide that guides the transfer material feeded by the transfer material feed unit to the transfer nip portion. This makes it possible to transport the transfer material in a more stable manner.

An image forming method according to an aspect of the invention includes: griping an image on an image carrier; feeding a transfer material to a transfer nip portion formed by a transfer roller with the image carrier by coming into contact with each other; holding the fed transfer material using a transfer material grip member that moves at a velocity that is slower than the feed velocity of the transfer material; and transferring the image held on the image carrier onto the transfer material by causing the transfer material caught by the transfer material grip member to pass through the transfer nip portion. This makes it possible to transfer the image onto the transfer material at an accurate position.

In an image forming method according to another aspect of the invention, the timing of the feed of the transfer material is determined based on a detection result from a detection unit that detects the movement position of the transfer material grip member in the circumferential direction of the transfer roller. This makes it possible to transfer the image onto the transfer material at an accurate position.

### BRIEF DESCRIPTION OF THE DRAWINGS

The invention will be described with reference to the accompanying drawings, wherein like numbers reference like elements.

FIG. 1 is a diagram illustrating the primary constituent elements of which an image forming apparatus according to an embodiment of the invention is configured.

FIG. 2 is a perspective view of a secondary transfer roller used in an image forming apparatus according to an embodiment of the invention.

FIG. 3 is a cross-section of a secondary transfer roller.

FIG. 4 is a partial cross-section of a secondary transfer roller.

FIG. 5 is a partial cross-section of a secondary transfer roller.

FIG. 6 is a diagram illustrating a position detection unit disposed in a secondary transfer roller.

FIG. 7 is a diagram illustrating a state in which a transfer material feed velocity is controlled based on position detection data.

FIG. 8 is a diagram illustrating a state in which the timing of writing to an exposure unit is controlled based on position detection data.

FIG. 9 is a partial cross-section of a secondary transfer roller.

FIG. 10 is a partial cross-section of a secondary transfer roller.

FIG. 11 is a diagram that defines the circumferential velocity of a transfer material grip member.

FIG. 12 is a diagram illustrating a method for measuring a transfer material feed velocity.

FIG. 13 is a diagram illustrating operations performed by a transfer material grip member and a separating member.

FIG. 14 is a diagram illustrating operations performed by a transfer material grip member and a separating member.

FIG. 15 is a diagram illustrating operations performed by a transfer material grip member and a separating member.

FIG. 16 is a diagram illustrating operations performed by a transfer material grip member and a separating member.

FIG. 17 is a diagram illustrating a transfer material transport unit.

FIGS. 18A and 18B are diagrams illustrating a guide unit.

### DESCRIPTION OF EXEMPLARY EMBODIMENTS

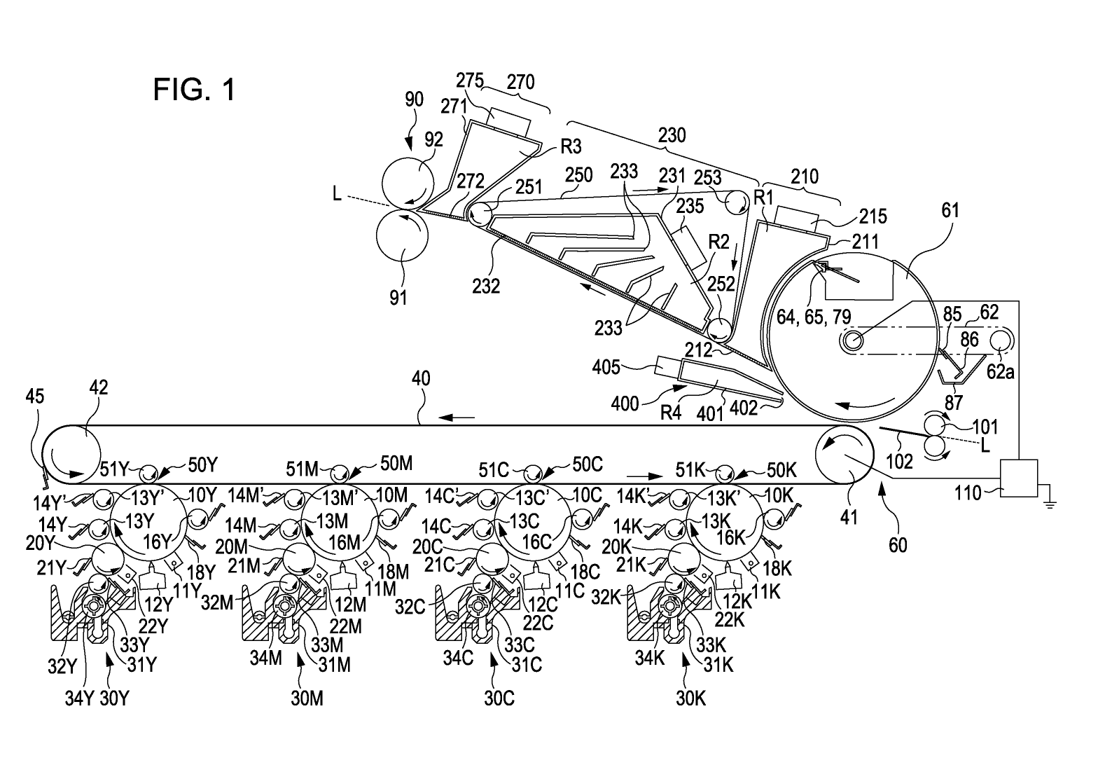

Embodiments of the invention will now be described with reference to the drawings. FIG. 1 is a diagram illustrating the primary constituent elements of which an image forming apparatus according to an embodiment of the invention is configured. Image forming units of respective colors are disposed in the central portion of the image forming apparatus, developing units 30Y, 30M, 30C, and 30K are disposed in the lower portion of the image forming apparatus, and elements such as a transfer belt 40, a secondary transfer unit 60, a fixing unit 90, and so on are disposed in the upper portion of the image forming apparatus. In particular, the fixing unit 90 is laid out above the transfer belt 40, thereby making it possible to reduce the installation footprint of the image forming apparatus as a whole. In this embodiment, the configuration is such that a transfer material such as paper that has undergone a secondary transfer in the secondary transfer unit 60 is pulled by a transfer material transport device 230, suction units 210 and 270, and so on and transported to the fixing unit 90, which makes it possible to realize such a layout.

The developing units 30Y, 30M, 30C, and 30K are respectively provided with photosensitive members 10Y, 10M, 10C, and 10K, corona charging units 11Y, 11M, 11C, and 11K, exposure units 12Y, 12M, 12C, and 12K, which are LED arrays or the like, and so on, for forming toner images. The photosensitive members 10Y, 10M, 10C, and 10K are uniformly charged by the corona charging units 11Y, 11M, 11C, and 11K, and the exposure units 12Y, 12M, 12C, and 12K expose the photosensitive members based on an inputted image signal, thereby forming electrostatic latent images on the photosensitive members 10Y, 10M, 10C, and 10K.

Generally speaking, the developing units 30Y, 30M, 30C, and 30K respectively include developing rollers 20Y, 20M, 20C, and 20K, developer reservoirs 31Y, 31M, 31C, and 31K that hold liquid developers of the colors yellow (Y), magenta (M), cyan (C), and black (K), anilox rollers 32Y, 32M, 32C, and 32K that serve as application rollers for applying the liquid developers of the stated colors from the developer reservoirs 31Y, 31M, 31C, and 31K onto the developing rollers 20Y, 20M, 20C, and 20K, and so on; electrostatic latent images formed upon the photosensitive members 10Y, 10M, 10C, and 10K are developed by the liquid developers of the stated colors.

The transfer belt 40 is an endless belt that is stretched around a driving roller 41 and a tension roller 42; the transfer belt 40 is rotationally driven by the driving roller 41 while making contact with the photosensitive members 10Y, 10M, 10C, and 10K at primary transfer sections 50Y, 50M, 50C, and 50K. The primary transfer sections 50Y, 50M, 50C, and 50K form a full-color toner image by sequentially transferring the developed toner images of the stated colors upon the photosensitive members 10Y, 10M, 10C, and 10K onto the transfer belt 40, thereby superimposing the toner images on one another, using the positions where the transfer belt 40 makes contact with the photosensitive members 10Y, 10M, 10C, and 10K located between the photosensitive members 10Y, 10M, 10C, and 10K and primary transfer rollers 51Y, 51M, 51C, and 51K as the transfer positions.

In the secondary transfer unit 60, a secondary transfer roller 61 is disposed opposite to the belt driving roller 41 with the transfer belt 40 therebetween; furthermore, a cleaning unit configured of a secondary transfer roller cleaning blade 62 is provided as well. A single-color toner image, a full-color toner image, or the like formed upon the transfer belt 40 is transferred onto a transfer material such as paper, film, cloth, or the like that is transported along a transfer material transport path L, at a transfer position where the secondary transfer roller 61 is disposed.

Furthermore, a first suction unit 210, a transfer material transport device 230, and a second suction unit 270 are arranged in that order downstream from the transfer material transport path L; the transfer material is thus transported to the fixing unit 90, where the single-color toner image, full-color toner image, or the like transferred onto the transfer material such as paper is fused to the transfer material such as paper and fixed thereto.

The transfer belt 40 is stretched around the tension roller 42, the belt driving roller 41, and so on; a cleaning unit configured of a transfer belt cleaning blade 49 is disposed at the location where the transfer belt 40 is stretched across the tension roller 42, and makes contact with the transfer belt 40, thereby cleaning residual toner, carrier, or the like from the surface of the transfer belt 40. Note that it is also possible to allocate the driving force for driving the transfer belt 40 to the tension roller 42 and use the belt driving roller 41 as a simple belt support roller.

The transfer material is supplied to the image forming apparatus by a paper supply unit (not shown). Transfer material set in such a paper supply unit is transported along the transfer material transport path L on a sheet-by-sheet basis at a predetermined timing. In the transfer material transport path L, the transfer material is transported to a secondary transfer position by gate rollers 101 and a transfer material transport guide 102, whereupon a single-color developed toner image, a full-color developed toner image, or the like formed upon the transfer belt 40 is transferred onto the transfer material. The transfer material that has undergone the secondary transfer is then transported to the fixing unit 90 by a transfer material transport unit whose central element is the transfer material transport device 230, as described above. The fixing unit 90 is configured of a heating roller 91 and a pressure roller 92 that is biased toward the heating roller 91 at a predetermined pressure; the transfer material is inserted into the nip between these rollers, and the single-color toner image, full-color toner image, or the like transferred onto the transfer material is then fused to and fixed upon the transfer material such as paper.

The developing units will be described hereinafter, but because the configurations of the image forming units and developing units are identical for each of the stated colors, the following descriptions will be given based on the yellow (Y) image forming unit and developing unit.

A photosensitive member cleaning roller 16Y, a photosensitive member cleaning blade 18Y, the corona charging unit 11Y, the exposure unit 12Y, the developing roller 20Y of the developing unit 30Y, a first photosensitive member squeeze roller 13Y, and a second photosensitive member squeeze roller 13Y′ are disposed in the image forming unit following the rotational direction of the external circumference of the photosensitive member 10Y.

The photosensitive member cleaning roller 16Y rotates in the counterclockwise direction while making contact with the photosensitive member 10Y, thereby cleaning residual liquid developer, untransferred liquid developer, and so on from the surface of the photosensitive member 10Y. A bias voltage for attracting toner particles within the liquid developer is applied to the photosensitive member cleaning roller 16Y, and the material collected by the photosensitive member cleaning roller 16Y is liquid developer that is rich in solid content, containing a large amount of toner particles.

The photosensitive member cleaning blade 18Y that makes contact with the photosensitive member 10Y downstream from the photosensitive member cleaning roller 16Y cleans liquid developer rich in carrier components from the surface of the photosensitive member 10Y.

A cleaning blade 21Y, the anilox roller 32Y, and a compaction corona generator 22Y are disposed around the outer surface of the developing roller 20Y in the developing unit 30Y. A regulation blade 33Y that adjusts the amount of liquid developer supplied to the developing roller 20Y makes contact with the anilox roller 32Y. An auger 34Y is contained within the liquid developer reservoir 31Y. Meanwhile, the primary transfer roller 51Y of the primary transfer unit is disposed in a position opposite to the photosensitive member 10Y, sandwiching the transfer belt 40 therebetween.

The photosensitive member 10Y is a photosensitive drum configured of a cylindrical member, with a photosensitive layer such as an amorphous silicon photosensitive material formed on the external circumferential surface thereof, and rotates in the clockwise direction.

The corona charging unit 11Y is disposed upstream in the rotational direction of the photosensitive member 10Y from the nip portion formed between the photosensitive member 10Y and the developing roller 20Y; a voltage is applied from a power source unit (not shown), thereby charging the photosensitive member 10Y with a corona discharge. The exposure unit 12Y is downstream from the corona charging unit 11Y in the rotational direction of the photosensitive member 10Y; the exposure unit 12Y irradiates the surface of the photosensitive member 10Y that has been charged by the corona charging unit 11Y with light, thereby forming a latent image upon the photosensitive member 10Y. Note that from the beginning to the end of the image forming process, elements such as rollers disposed in earlier stages are defined as being upstream from elements such as rollers disposed in later stages.

The developing unit 30Y includes the compaction corona generator 22Y that has a compaction effect, and the developer reservoir 31Y that holds liquid developer in a state in which the toner within the carrier is dispersed at a weight ratio of approximately 20%.

Furthermore, the developing unit 30Y includes the developing roller 20Y that holds the stated liquid developer; the anilox roller 32Y, which is an application roller for applying the liquid developer to the developing roller 20Y; the regulation blade 33Y that regulates the amount of liquid developer applied to the developing roller 20Y; the auger 34Y that supplies the liquid developer to the anilox roller 32Y while agitating and transporting the liquid developer; the compaction corona generator 22Y that places the liquid developer held on the developing roller 20Y into a state of compaction; and the developing roller cleaning blade 21Y that cleans the developing roller 20Y.

The liquid developer held in the developer reservoir 31Y is a non-volatile liquid developer, which is non-volatile at normal temperatures, and which has a high concentration and high viscosity, rather than a volatile liquid developer that uses Isopar (an Exxon brand) as its carrier, which is volatile at normal temperatures, has a low concentration (approximately 1-3 wt %), and that has a low viscosity, as has generally been used in the past. In other words, the liquid developer in the invention is a high-viscosity liquid developer (that is, a viscoelasticity of approximately 30 to 300 mPa·s at a shear rate of 1000 (1/s) at 25° C., measured using a HAAKE RheoStress RS600) with a toner solid content concentration of approximately 15 to 25%, in which solid particles of a colorant such as a pigment having an average particle diameter of 1 μm are dispersed within a thermoplastic resin and are added to a liquid carrier such as an organic carrier, silicon oil, mineral oil, or cooking oil along with a dispersant.

The anilox roller 32Y functions as an application roller that supplies and applies liquid developer to the developing roller 20Y. The anilox roller 32Y is a cylindrical member, and is a roller whose surface is formed as a non-planar surface by engraving minute channels in a uniform helical pattern in that surface so as to make it easier for the surface to hold developer. The liquid developer is supplied from the developer reservoir 31Y to the developing roller 20Y by this anilox roller 32Y. As shown in FIG. 1, when the apparatus is operating, the auger 34Y rotates in the counterclockwise direction, supplying the liquid developer to the anilox roller 32Y; the anilox roller 32Y, meanwhile, rotates in the counterclockwise direction, and applies the liquid developer to the developing roller 20Y.

The regulation blade 33Y is an elastic blade configured with an elastic member covering the surface thereof, and is configured of a rubber portion made up of urethane rubber or the like that makes contact with the surface of the anilox roller 32Y. The regulation blade 33Y adjusts the amount of liquid developer supplied to the developing roller 20Y by regulating and adjusting the film thickness and amount of the liquid developer held and transported by the anilox roller 32Y.

The developing roller cleaning blade 21Y is configured of rubber or the like that makes contact with the surface of the developing roller 20Y; the developing roller cleaning blade 21Y is disposed downstream, in the rotational direction of the developing roller 20Y, from a developing nip portion formed where the developing roller 20Y and the photosensitive member 10Y make contact with each other, and removes residual liquid developer from the developing roller 20Y by wiping off that liquid developer.

The compaction corona generator 22Y is an electrical field application unit that increases the charge bias on the surface of the developing roller 20Y; an electrical field is applied from the compaction corona generator 22Y towards the developing roller 20Y by the compaction corona generator 22Y at a compaction position. Note that the electrical field application unit for this compaction may employ a compaction roller, rather than employing a corona discharge from a corona discharge unit as shown in FIG. 1.

The developer held on the developing roller 20Y that has undergone compaction is developed in correspondence with the latent image on the photosensitive member 10Y by a predetermined electrical field being applied at the developing nip portion where the developing roller 20Y and the photosensitive member 10Y make contact with each other.

The developer remaining after this developing is wiped off and removed by the developing roller cleaning blade 21Y; the removed developer drops into a collection receptacle within the developer reservoir 31Y, and is reused. Note that the carrier and toner reused in this manner are not in a mixed-color state.

A photosensitive member squeeze unit disposed upstream from the primary transfer position is disposed downstream from the developing roller 20Y and opposite to the photosensitive member 10Y; the photosensitive member squeeze unit collects the residual carrier of the developed toner image that remains on the photosensitive member 10Y. This photosensitive member squeeze unit is configured of the first photosensitive member squeeze roller 13Y and the second photosensitive member squeeze roller 13Y′, both of which are configured of elastic roller members that rotate while sliding on the photosensitive member 10Y; the photosensitive member squeeze unit has a function for collecting residual carrier and originally unnecessary fog toner from the toner image developed upon the photosensitive member 10Y, thereby increasing the toner particle ratio within the visualized image (toner image). Note that a predetermined bias voltage is applied to the photosensitive member squeeze rollers 13Y and 13Y′.

Having passed the squeeze unit configured of the first photosensitive member squeeze roller 13Y and the second photosensitive member squeeze roller 13Y′ mentioned above, the surface of the photosensitive member 10Y proceeds to the primary transfer section 50Y. At the primary transfer section 50Y, the developer image developed on the photosensitive member 10Y is transferred to the transfer belt 40 by the primary transfer roller 51Y. Furthermore, at the primary transfer section, the toner image upon the photosensitive member 10 is transferred onto the transfer belt 40 due to the effects of the transfer bias applied to the primary transfer backup roller 51. Here, the configuration is such that the photosensitive member 10Y and the transfer belt 40 move at the same velocity, thereby reducing the driving burden for rotation and movement as well as suppressing disturbances to the visualized toner image on the photosensitive member 10Y.

Magenta (M), cyan (C), and black (K) toner images are formed upon the photosensitive members 10M, 10C, and 10K, respectively, in the respective developing units 30M, 30C, and 30K, through the same process as the aforementioned developing process of the developing unit 30Y. The transfer belt 40 passes through the nips of the primary transfer sections 50 for the colors yellow (Y), magenta (M), cyan (C), and black (K), whereby the developer (developed images) upon the photosensitive members for each color are transferred thereto and superimposed upon each other as a result; the transfer belt 40 then enters into the nip portion of the secondary transfer unit 60.

Having passed the secondary transfer unit 60, the transfer belt 40 makes another pass in order to pick up a transfer image at the primary transfer sections 50, but the transfer belt 40 is cleaned by the transfer belt cleaning blade 45 upstream from the primary transfer sections 50.

The transfer belt 40 has a three-layer structure, in which a polyurethane elastic intermediate layer is provided upon a polyimide base layer, and a PFA surface layer is provided thereupon. This transfer belt 40 is used in a state in which it is stretched across the belt driving roller 41 and the tension roller 42 on the side of the polyimide base layer, and the toner images are transferred on the side of the PFA surface layer. The transfer belt 40 having elasticity and formed in this manner has favorable tracking and response properties with respect to the surface of the transfer material, and therefore is useful when, during the secondary transfer, toner particles, and particularly toner particles with small particle diameters, are applied to the pits in the transfer material in order to carry out the transfer.

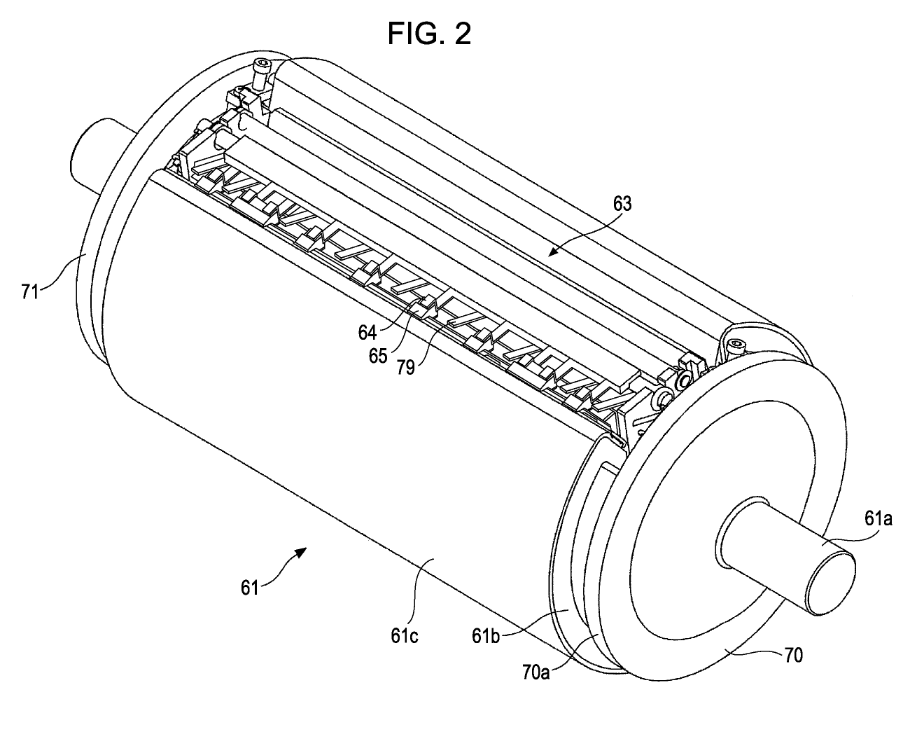

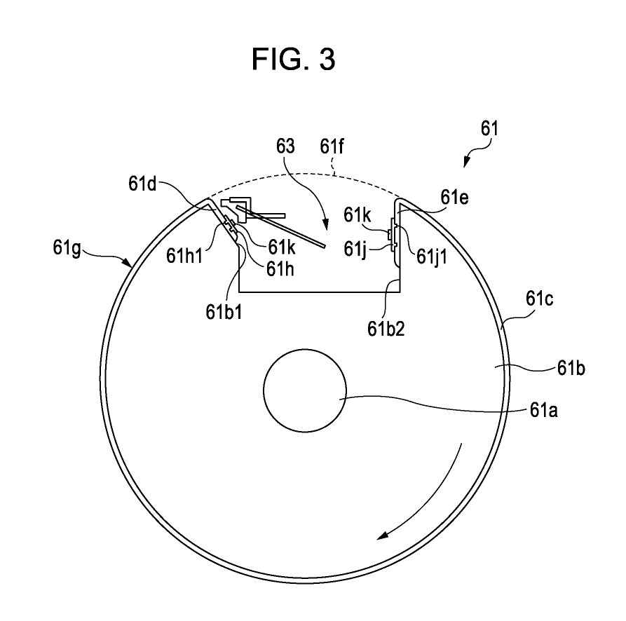

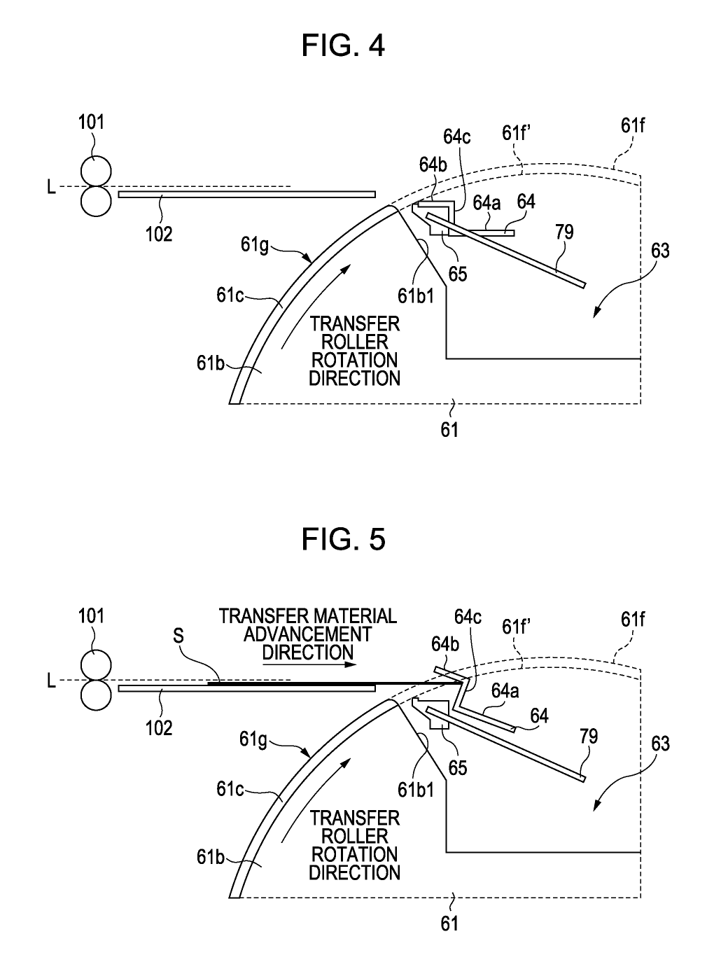

Next, the secondary transfer roller 61 used in the image forming apparatus according to this embodiment will be described in detail. FIG. 2 is a perspective view of the secondary transfer roller used in the image forming apparatus according to an embodiment of the invention; FIG. 3 is a cross-section thereof; and FIG. 4 is a partial cross-section thereof.

The secondary transfer roller 61 includes transfer material grip members 64, grip member receiving portions 65, and an recessed portion 63 that serves as a support portion for separating members 79. As shown in FIG. 2, the recessed portion 63 extends in the axial direction of the secondary transfer roller 61. Furthermore, the secondary transfer roller 61 includes a rubber sheet 61c serving as an elastic member wrapped around the outer circumferential surface of a contact portion 61g, which is a circular arc portion where a conductive base member 61b makes contact with the transfer belt 40. A low-resistance layer is formed upon the circular arc contact portion 61g of the secondary transfer roller 61 by this rubber sheet 61c. The rubber sheet 61c has a three-layer structure, with a base layer, an elastic layer, and a surface layer. The base layer is approximately 80 to 90 μm thick, and is formed using, for example, a polyimide resin. The elastic layer is approximately 0.5 to 5 mm thick, and is formed using, for example, urethane rubber. Finally, the surface layer is approximately 5 to 25 μm thick, and is formed using, for example, fluorocarbon rubber. The volume resistivity of the rubber sheet 61c is 1×10⁶ to 1×10¹¹Ω.

As shown in FIG. 3, the end portions 61d and 61e of the rubber sheet 61c are anchored to wall surfaces 61b1 and 61b2, respectively, formed on the inside of the recessed portion, formed in the base member 61b; the other portions of the rubber sheet 61c are simply wrapped around the base member 61b, and are not bonded or anchored thereto. For example, plates 61h and 61j extending in the direction of a rotational shaft 61a may be provided upon the end portions 61d and 61e, respectively, of the rubber sheet 61c, and fastened to the base member 61b using pins 61k, screws, or the like. Protrusions 61h1 and 61j1 are formed in the plates 61h and 61j, respectively, and the plates 61h and 61j are strongly anchored by pressing those protrusions 61h1 and 61j1 into the rubber sheet 61c. Note that anchoring the end portions 61d and 61e of the rubber sheet 61c to the recessed portion 63 is not limited to this method, and other methods may be used instead.

As shown in FIG. 4, each transfer material grip member 64, serving as a transfer material grip portion, and each grip member receiving portion 65, in which a corresponding transfer material grip member 64 can be seated or left, are provided in the vicinity of the wall surface 61b1 in the recessed portion 63 on the downstream side in the rotational direction of the secondary transfer roller 61. An arbitrary number of transfer material grip members 64 can be provided along the axial direction of the secondary transfer roller 61. Each transfer material grip member 64 is formed in the same shape and/or the same size, from a thin metal band-shaped plate. As one example, the transfer material grip members 64 may be formed by bending the plates into a crank shape. One end portion of each transfer material grip member 64 is an anchoring end portion 64a, whereas the other end portion of each transfer material grip member 64 is a grip portion 64b seated on the corresponding grip member receiving portion 65. The grip portion 64b grips and holds a tip portion Sa of a transfer material S between itself and the corresponding grip member receiving portion 65. Furthermore, each transfer material grip member 64 includes a bent portion 64c formed between the anchored end portion 64a and the grip portion 64b.

The circumferential length of the secondary transfer roller 61 is set so as to be greater than the length of the transfer material movement direction of the type of transfer material S that, of the types of transfer materials S used by the image forming apparatus 1 in this example, has the maximum length in the transfer material movement direction. To be more specific, the circumferential length of the contact portion 61g of the secondary transfer roller 61, excluding the span of the recessed portion 63 in the secondary transfer roller rotational direction, is set to be greater than the maximum length of the stated transfer material S in the transfer material movement direction. Through this, toner images on the transfer belt 40 can be transferred with certainty to a transfer material S having the stated maximum length in the transfer material movement direction as well.

As shown in FIG. 2, the secondary transfer roller 61 is provided with contact members 70 and 71 that rotate integrally with the secondary transfer roller 61. The contact members 70 and 71 have circular arc-shaped outer surfaces 70a and 71a, respectively, forming a concentric circle with respect to the secondary transfer roller 61. The contact members 70 and 71 directly or indirectly make contact with the belt driving roller 41 when the recessed portion 63 of the secondary transfer roller 61 opposes the location of a pressure nip formed with the belt driving roller 41.

As shown in FIG. 2, the grip member receiving portions 65 are disposed along the axial direction of the secondary transfer roller 61, the number of grip member receiving portions 65 corresponding to the number of transfer material grip members 64. Furthermore, the separating members 79 are provided within the recessed portion 63. As shown in FIG. 4, each separating member 79 is disposed along the axial direction of the secondary transfer roller 61. An arbitrary number of separating members 79 can be provided. Furthermore, the grip member receiving portions 65 are disposed so as to be located between adjacent separating members 79. Each separating member 79 is formed in the same shape and size, from a thin metal band-shaped plate. Although not shown here, the separating members 79 are integrally connected to each other by a connection portion, and thus have a comb-tooth shape.

As shown in FIG. 4, the transfer material grip members 64, grip member receiving portions 65, and separating members 79 are supported in the vicinity of the wall surface 61b1 on the downstream side in the rotational direction of the secondary transfer roller 61 within the recessed portion 63, so as to be located within an imaginary circle 61f extending from the contact portion 61g where the base member 61b around which the rubber sheet 61c is wrapped makes contact with the transfer belt 40.

As shown in FIG. 5, the transfer material grip members 64, which are set at an open position, approach a supply position of the transfer material S due to the rotation of the secondary transfer roller 61. At this time, the tip portions of the grip portions 64b of the transfer material grip members 64 are in a position protruding beyond the imaginary circle 61f extending from the contact portion 61g where the base member 61b around which the rubber sheet 61c is wrapped makes contact with the transfer belt 40.

The rotation of the belt driving roller 41, the rotation of the secondary transfer roller 61, and the rotation of the gate roller 101 are controlled in a synchronized manner so that the toner image on the transfer belt 40 is transferred onto a predetermined position of the transfer material S at the transfer nip portion. At this time, the circumferential velocity of the secondary transfer roller 61 (in other words, the movement velocity of the transfer material grip members 64) is set to be lower than the movement velocity of the transfer material S. The tip portion of the transfer material S advances into the space between the transfer material grip members 64 and the grip member receiving portions 65, and makes contact with the borderlines between the grip portions 64b and the bent portions 64c of the transfer material grip members 64. Upon doing so, due to the velocity difference between the circumferential velocity of the secondary transfer roller 61 and the movement velocity of the transfer material S, the tip portion of the transfer material S makes contact with the borderlines between the grip portions 64b and the bent portions 64c and is positioned relative to the transfer material grip members 64; in addition, the tip portion Sa of the transfer material S flexes. Because the tip portion Sa of the transfer material S flexes due to the velocity difference, a buffer is provided for positioning the transfer material S, enabling the transfer material to be positioned in a stable manner. The timing at which the tip portion of the transfer material S makes contact with the borderlines between the grip portions 64b and the bent portions 64c, of which a positioning portion is configured, is the timing at which the wall surface 61b2 within the recessed portion 63 on the upstream side in the rotational direction of the secondary transfer roller 61 reaches the location of the nip portion formed with the transfer belt 40, and the recessed portion 63 faces the location corresponding to the nip due to further rotation of the secondary transfer roller 61.

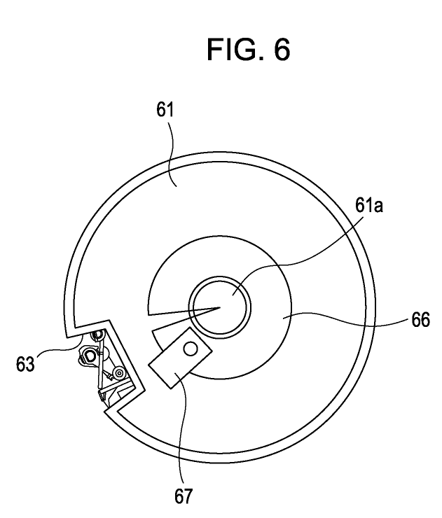

FIG. 6 is a diagram illustrating the disposition of a position detection unit for accurately positioning the transfer material S. With the position detection unit, a photosensor cam 66 that rotates integrally with the shaft 61a of the secondary transfer roller 61 is provided. A cutout portion 66a is provided in the photosensor cam 66 in association with the position of the recessed portion 63 of the secondary transfer roller 61. A photosensor 67, serving as the position detection unit, is disposed facing the photosensor cam 66, and is anchored to a side plate or the like.

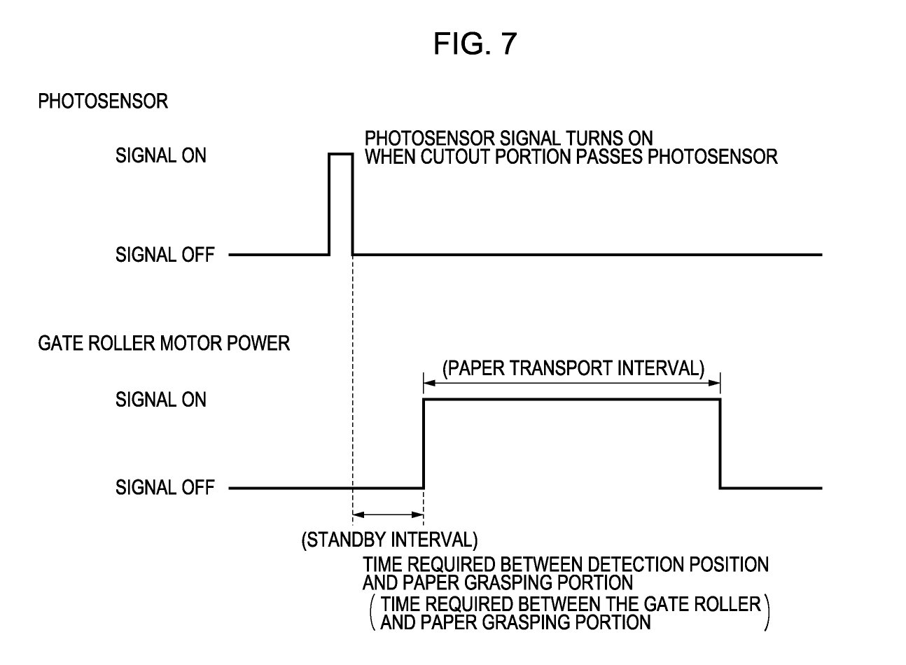

FIG. 7 is a diagram illustrating a state in which the rotation of a motor that drives the gate roller 101 that feeds the transfer material S is controlled by an electronic control device (control unit) in the image forming apparatus based on position detection data for the secondary transfer roller 61 obtained by the position detection unit shown in FIG. 6.

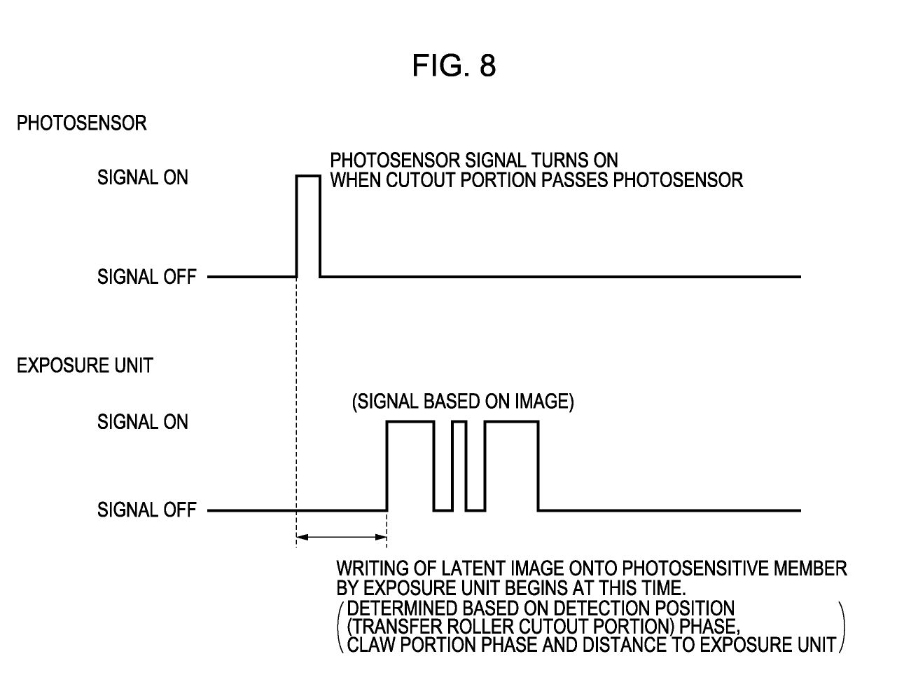

FIG. 8, meanwhile, is a diagram illustrating a state in which the timing of writing performed by the exposure unit 11Y is controlled by the electronic control device (control unit) in the image forming apparatus based on the position detection data for the secondary transfer roller 61 obtained by the position detection unit shown in FIG. 6.

During the process for transporting the transfer material S from the gate roller 101 up until the transfer material S makes contact with the borderlines between the grip portions 64b and the bent portions 64c, of which the positioning portion is configured, disturbances occur in the movement velocity of the transfer material S when the transfer material S makes contact with the contact portion 61g where the rubber sheet 61c is wrapped around the secondary transfer roller 61. Accordingly, even if the rotation of the belt driving roller 41, the rotation of the secondary transfer roller 61, and the rotation of the gate roller 101 are controlled in a synchronized manner, error will arise in the positioning of the transfer material S, and thus a problem in which the toner image upon the transfer belt 40 cannot be transferred to an accurate position on the transfer material S will occur.

As a measure against this, the transfer material transport guide 102 is disposed between the gate roller 101 and the nip portion formed between the secondary transfer roller 61 and the transfer belt 40, as shown in FIG. 5. The distance between an exit portion of the transfer material transport guide 102 and the nip portion formed between the secondary transfer roller 61 and the transfer belt 40 is reduced to the greatest extent possible. Note, however, that it is possible to omit the transfer material transport guide 102 in the case where the distance between the gate roller 101 and the nip portion formed between the secondary transfer roller 61 and the transfer belt 40 is short.

It is preferable for the transfer material grip members 64, the grip member receiving portions 65, and the separating members 79 supported within the recessed portion 63 to be disposed as close as possible to the wall surface 61b1 within the recessed portion 63 on the downstream side of the rotational direction of the secondary transfer roller 61. Accordingly, there is the risk that the contact portion 61g will overlap with a straight line that connects the exit portion of the transfer material transport guide 102 with the borderlines between the grip portions 64b and the bent portions 64c, of which the positioning unit is configured, in the grip members.

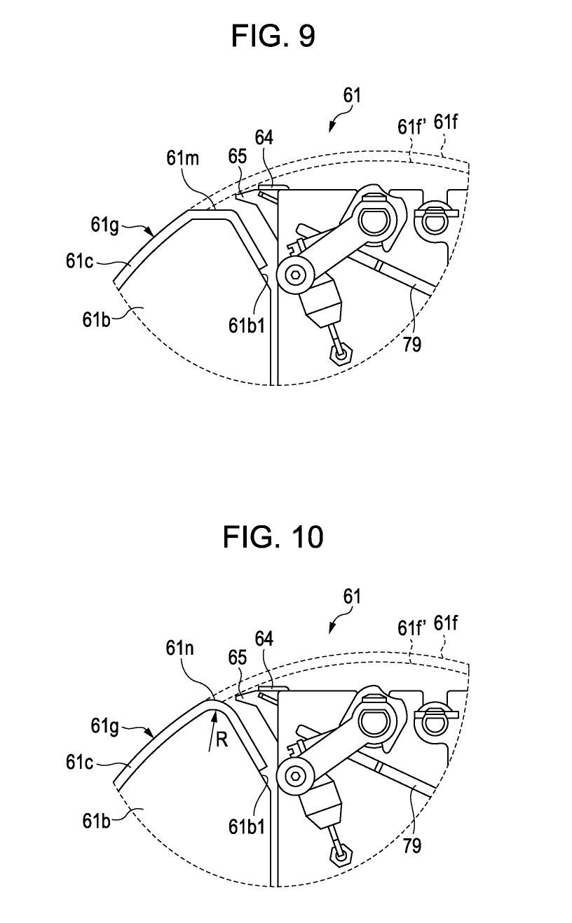

FIG. 9 is a diagram illustrating an embodiment that prevents the borderline portion between the contact portion 61g and the wall surface 61b1 from overlapping with a straight line that connects the exit portion of the transfer material transport guide 102 with the borderlines between the grip portions 64b and the bent portions 64c, of which the positioning unit is configured, in the grip members. As shown in FIG. 9, a planar cut portion 61m is formed in the borderline portion between the contact portion 61g and the wall surface 61b1. By forming the planar cut portion 61m at the borderline portion, the contact portion 61 upon which is wrapped the rubber sheet 61c is not present upon a straight line that connects the exit portion of the transfer material transport guide 102 with the borderlines between the grip portions 64b and the bent portions 64c, of which the positioning unit is configured, in the grip members. Accordingly, during the process for transporting the transfer material S from the gate roller 101 up until the transfer material S makes contact with the borderlines between the grip portions 64b and the bent portions 64c, of which the positioning portion is configured, the transfer material S is prevented from making contact with the contact portion 61 upon which the rubber sheet 61c is wrapped, thereby making it possible to accurately position the transfer material S.

FIG. 10 is a diagram illustrating another embodiment that prevents the borderline portion between the contact portion 61g and the wall surface 61b1 from overlapping with a straight line that connects the exit portion of the transfer material transport guide 102 with the borderlines between the grip portions 64b and the bent portions 64c, of which the positioning unit is configured, in the grip members. As shown in FIG. 10, an rounded portion 61n is formed in the borderline portion between the contact portion 61g and the wall surface 61b1. By forming the R portion 61n at the borderline portion, the contact portion 61 upon which is wrapped the rubber sheet 61c is not present upon a straight line that connects the exit portion of the transfer material transport guide 102 with the borderlines between the grip portions 64b and the bent portions 64c, of which the positioning unit is configured, in the grip members. Accordingly, during the process for transporting the transfer material S from the gate rollers 101 and 101′ up until the transfer material S makes contact with the bent portions 64c, of which the positioning unit is configured, the transfer material S is prevented from making contact with the contact portion 61 upon which the rubber sheet 61c is wrapped, thereby making it possible to accurately position the transfer material S.

In this embodiment, the transfer material feed velocity of the gate roller 101 is 255 mm/s, whereas the circumferential velocity of the outer circumferential surface of the secondary transfer roller 61 is 250 mm/s (the radius extending to the outer circumference of the secondary transfer roller is 95.5 mm).

Accordingly, the secondary transfer roller 61 rotates at angular velocity ω=250/95.5=2.62 (rad/s).

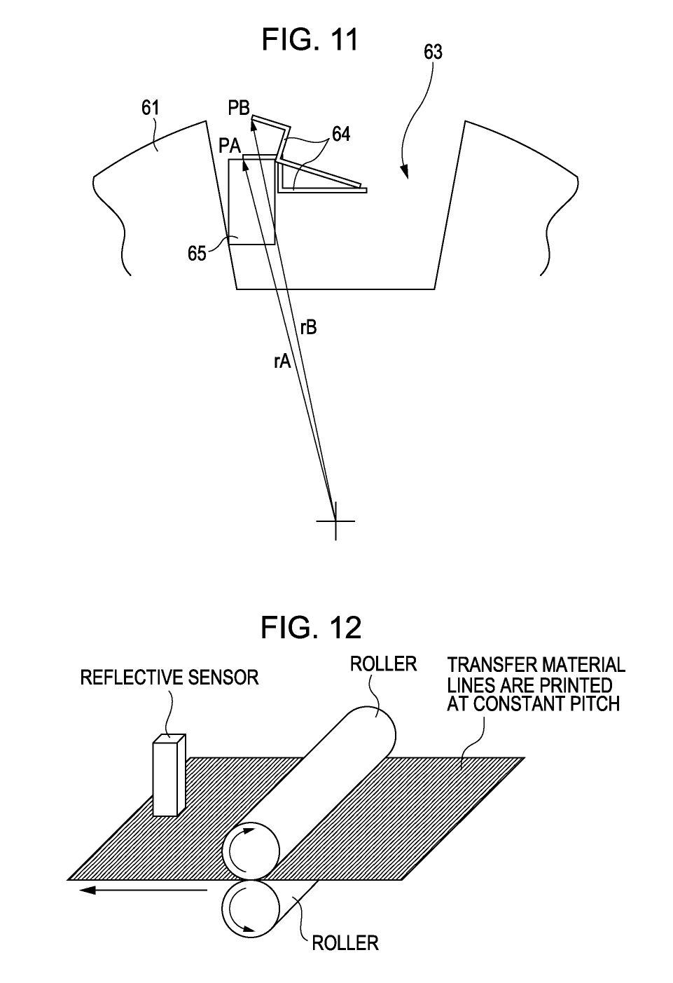

FIG. 11 is a diagram that defines the circumferential velocity of the transfer material grip members 64. When opening or closing in order to hold the transfer material S, the transfer material grip members 64 move in the radial direction. If the secondary transfer roller 61 is rotating at an angular velocity with constant conditions, the circumferential velocity of the tip portions of the transfer material grip members 64 changes by that amount. In this embodiment, a distance rA between the tip portions of the transfer material grip members 64 and the rotational center of the secondary transfer roller 61 in a state in which the transfer material S is caught is 85 mm, whereas distance rB between the tip portions of the transfer material grip members 64 and the rotational center of the secondary transfer roller 61 in a state in which the transfer material grip members 64 have moved the maximum amount in the radial direction is 97 mm. Therefore, the rotational velocity when the tip portions of the transfer material grip members 64 are in a position A is 223 mm/s, whereas the rotational velocity when the tip portions of the transfer material grip members 64 are in a position B is 251 mm/s; in either case (particularly when the transfer material grip members 64 have moved outside of the circumference) the rotational velocity is less than the transfer material feed velocity of 255 mm/s for the gate roller 101.

With respect to the movement velocity of the transfer material grip members 64, first, an angular velocity ω is measured by providing a rotation detection unit such as a rotary encoder or the like in the shaft 61a of the secondary transfer roller 61. Next, a distance r from the rotational center of the secondary transfer roller 61 to the tip portions of the transfer material grip members 64 is measured, and the movement velocity of the transfer material grip members 64 is calculated as V=r×ω.

FIG. 12 is a diagram illustrating a method for measuring the transfer material feed velocity for the gate roller 101. First, a transfer material on which fine lines are printed at an even pitch (for example, 100 μm) in the main scanning direction (that is, the widthwise direction) is prepared, and the temporal interval between the fine lines when that transfer material is passed through the gate nip is measured using an optical measurement unit such as a reflective sensor or the like, thereby calculating the transfer material feed velocity of the transfer material. For example, in the case where the time detected by the reflective sensor for the pitch is 0.0004 sec (0.4 μsec), the feed velocity of the transfer material is (100×10−3)/0.0004=250.0 mm/s.

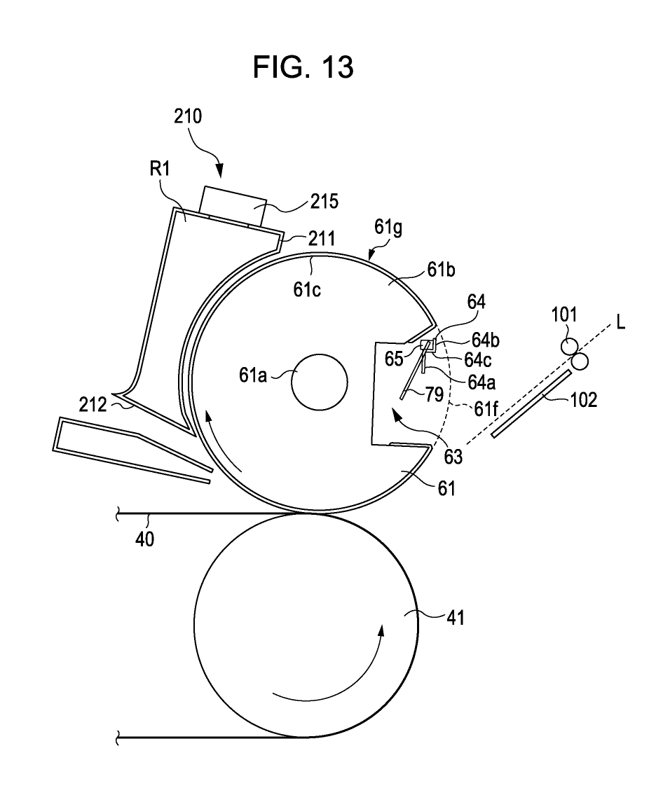

The transfer of a toner image onto the transfer material S by the secondary transfer unit 60 will now be described using FIGS. 13 to 16.

When the transfer belt 40 begins to rotate due to the rotation of the belt driving roller 41, the secondary transfer roller 61 also rotates. At this time, as shown in FIG. 13, the grip portions 64b of the transfer material grip members 64 are seated on the corresponding grip member receiving portions 65. Furthermore, the separating members 79 are set to a retracted position. In this state, the transfer material grip members 64, the grip member receiving portions 65, and the separating members 79 are located within the imaginary circle 61f extending from the contact portion 61g where the base member 61b around which the rubber sheet 61c is wrapped makes contact with the transfer belt 40, and within an imaginary circle 61f′ in a state in which the rubber sheet 61c is not wrapped around the base member 61b.

As a toner image held on the transfer belt 40 approaches the secondary transfer unit 60, each transfer material grip member 64 begins to separate from its corresponding grip member receiving portion 65.

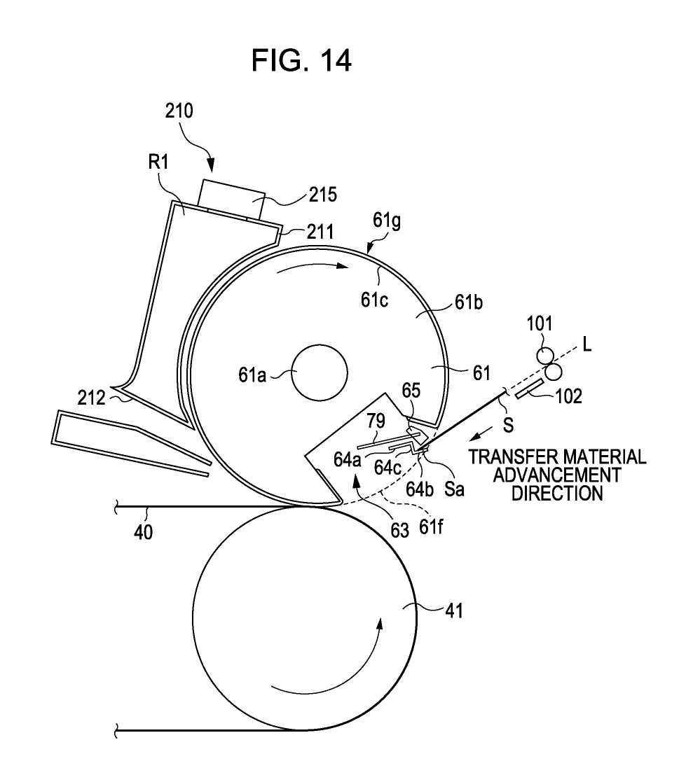

As shown in FIG. 14, the transfer material grip members 64, which are set at an open position, approach the supply position of the transfer material S due to the rotation of the secondary transfer roller 61. At this time, the tip portions of the grip portions 64b of the transfer material grip members 64 are in a position protruding beyond the imaginary circle 61f extending from the contact portion 61g where the base member 61b around which the rubber sheet 61c is wrapped makes contact with the transfer belt 40; however, because they have not yet reached the position of contact with the transfer belt 40, the grip portions 64b do not make contact with the transfer belt 40. Meanwhile, the transfer material S is supplied toward the secondary transfer roller 61, and the toner image held on the transfer belt 40 approaches the secondary transfer unit 60. The rotation of the belt driving roller 41, the rotation of the secondary transfer roller 61, and the rotation of the gate roller 101 are controlled in a synchronized manner so that the toner image on the transfer belt 40 is transferred onto a predetermined position of the transfer material S at the transfer nip portion. At this time, the circumferential velocity of the secondary transfer roller 61 (in other words, the movement velocity of the transfer material grip members 64) is set to be lower than the movement velocity of the transfer material S.

The tip portion of the transfer material S advances into the space between the transfer material grip members 64 and the grip member receiving portions 65, and makes contact with the borderlines between the grip portions 64b and the bent portions 64c of the transfer material grip members 64, of which the positioning portion is configured. Upon doing so, due to the velocity difference between the circumferential velocity of the secondary transfer roller 61 and the movement velocity of the transfer material S, the tip portion of the transfer material S makes contact with the borderlines between the grip portions 64b and the bent portions 64c and is positioned relative to the transfer material grip members 64; in addition, the tip portion Sa of the transfer material S flexes. The timing at which the tip portion of the transfer material S makes contact with the borderlines between the grip portions 64b and the bent portions 64c, of which a positioning portion is configured, is the timing at which the wall surface 61b2 within the recessed portion 63 on the upstream side in the rotational direction of the secondary transfer roller 61 reaches the location of the nip portion formed with the transfer belt 40, and the recessed portion 63 faces the location corresponding to the nip due to further rotation of the secondary transfer roller 61. Meanwhile, the transfer material S does not make contact with the contact portion formed by the wrapped rubber sheet 61c from when the transfer material S passes through the gate roller 101 to when the transfer material S makes contact with the positioning portion, and therefore the transfer material S can be positioned accurately without fluctuations in velocity.

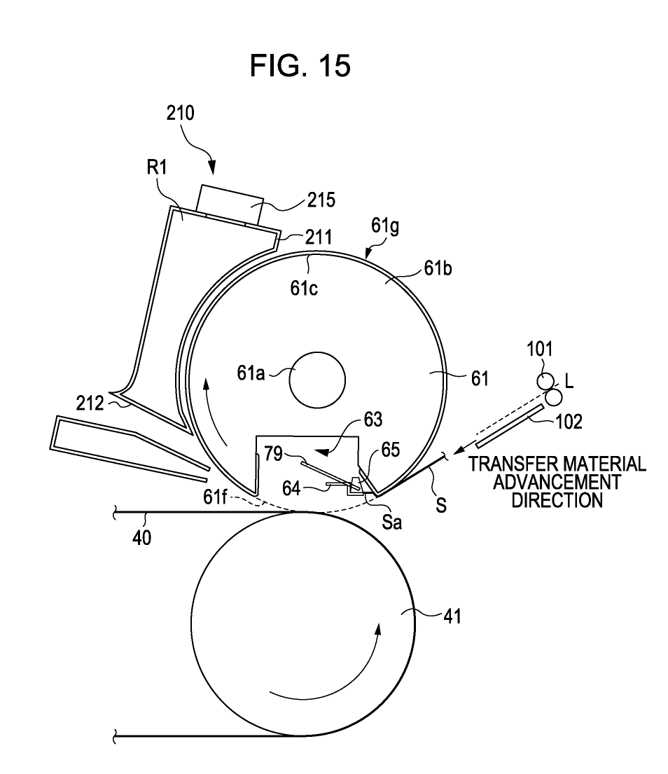

Next, part of the transfer material S makes contact with the outer circumferential surface of the secondary transfer roller 61, and curls along that external circumferential surface. Each transfer material grip member 64 then begins to approach its corresponding grip member receiving portion 65. Then, as shown in FIG. 15, each transfer material grip member 64 presses the tip portion Sa of the transfer material S against the corresponding grip member receiving portion 65, griping the tip portion Sa in that position. In this state, the grip portions 64b are located within the imaginary circle 61f extending from the contact portion 61g where the base member 61b around which the rubber sheet 61c is wrapped makes contact with the transfer belt 40, and within the imaginary circle 61f′ in a state in which the rubber sheet 61c is not wrapped around the base member 61b, and thus the grip portion 64b does not make contact with the transfer belt 40. In this manner, the transfer material S is positioned with respect to the secondary transfer roller 61, and moves toward the transfer nip with certainty along with the rotation of the secondary transfer roller 61. At this time, the separating members 79 are held in the retracted position.

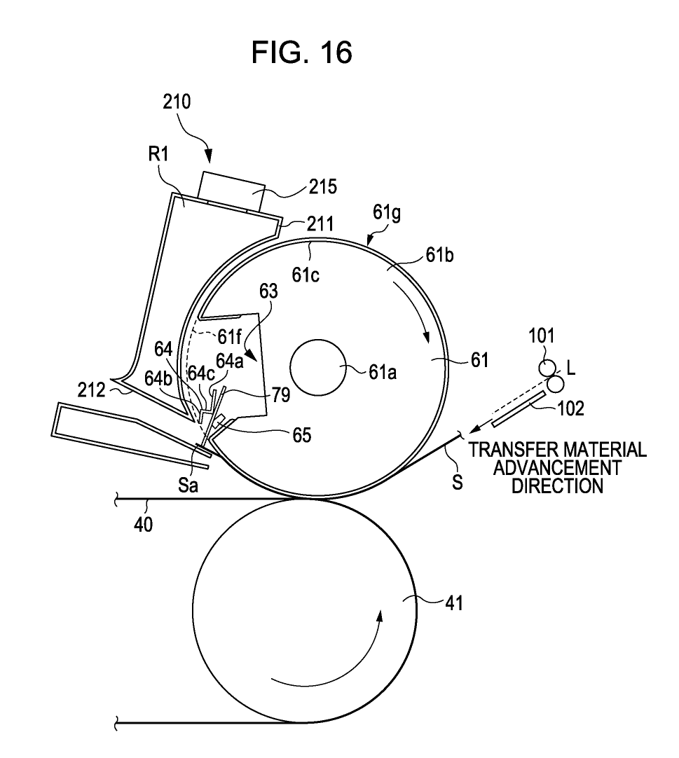

The toner image on the transfer belt 40 is transferred to the transfer material S at the transfer nip. When the grip portions 64a of the transfer material grip members 64 and the tip portion Sa of the transfer material S pass the transfer nip, the transfer material grip members 64 begin to move in the direction away from the grip member receiving portions 65, thereby releasing the tip portion Sa of the transfer material S, as shown in FIG. 16. Then, the separating members 79 are set to a protruding position as the secondary transfer roller 61 rotates further. In the state, the tips of the transfer material grip members 64 and the separating members 79 are in a position protruding from the imaginary circle 61f extending from the contact portion 61g where the base member 61b around which the rubber sheet 61c is wrapped makes contact with the transfer belt 40, but because this is after those tips have passed the position of contact with the transfer belt 40, the tips of the transfer material grip members 64 and the separating members 79 do not make contact with the transfer belt 40.

Meanwhile, the tip portion Sa of the transfer material S that was released from its hold by the transfer material grip members 64 is lightly pushed toward the secondary transfer roller 61 by air blowing from a blowing unit 400, which will be described later, and is pushed in the direction away from the contact portion 61g of the secondary transfer roller 61 by the separating members 79. In this manner, the tip portion Sa of the transfer material S is guided toward the transfer material transport unit. The transfer material S gripped by the nip portion between the belt driving roller 41 and the secondary transfer roller 61 moves to the transfer material transport unit due to further rotation of the belt driving roller 41 and the secondary transfer roller 61. In other words, the portion of the transfer material S for which transfer is complete separates while the toner image on the transfer belt 40 undergoes the secondary transfer onto the transfer material S (a transfer separation process). Note that the air blowing performed by the blowing unit 400 may be omitted in the case where the transfer material S has a low elastic restitution force and is flimsy.

In the secondary transfer process for transferring a toner image onto the transfer material S, as shown in FIGS. 13 to 16, the transfer material grip members 64, the grip member receiving portions 65, and the separating members 79 are supported within the recessed portion 63 so as not to make contact with the transfer belt 40. Because the transfer material grip members 64, the grip member receiving portions 65, and the separating members 79 do not make contact with the transfer belt 40 during the secondary transfer process, damage to the transfer belt 40 due to the stated members making contact with the transfer belt 40 can be prevented, and furthermore, rotational disturbances and fluctuations in the contact pressure of the secondary transfer roller 61 can be prevented, thereby preventing the occurrence of banding. Furthermore, the transfer material S does not make contact with the contact portion formed by the wrapped rubber sheet 61c from when the transfer material S passes through the gate roller pair 101 and 101′ to when the transfer material S makes contact with the bent portion 64c, and therefore the transfer material S can be positioned accurately without fluctuations in the supply velocity. In addition, by disposing a position detection sensor that detects the position of the transfer material grip members 64 in the secondary transfer roller 61 and controlling the timing of image formation, the timing of the feed of the transfer material S from the gate roller pair 101, 101′, and so on based on a signal from the position detection sensor, it is possible to position the transfer material S more accurately.

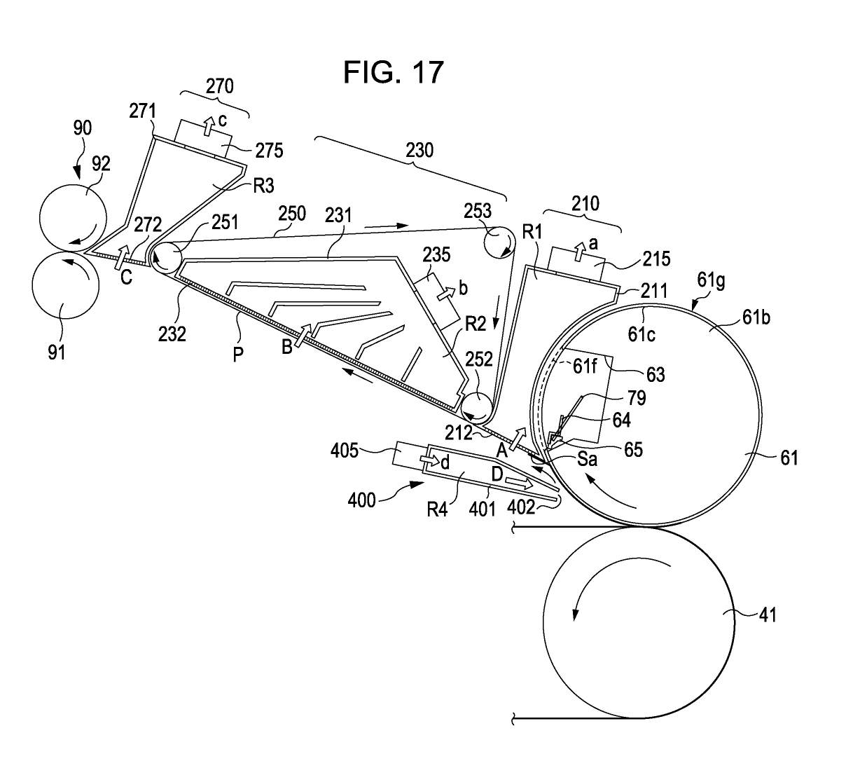

The transfer material S is then transported to the fixing unit 90, and a transport unit for carrying out this transfer will be described next. FIG. 17 is a diagram illustrating a transfer material transport unit used in the image forming apparatus according to this embodiment of the invention. In FIG. 17, 210 indicates a first suction unit, 211 indicates a housing portion, 212 indicates a suction surface, 215 indicates an airflow production unit, 230 indicates the transfer material transport device, 231 indicates a housing portion, 232 indicates a suction surface, 233 indicates partition members, 235 indicates an airflow production unit, 250 indicates a transfer material transport member, 251 indicates a transfer material transport member driving roller, 252 and 253 indicate transfer material transport member support rollers, 270 indicates a second suction unit, 271 indicates a housing portion, 272 indicates a suction surface, 275 indicates an airflow production unit, 400 indicates the blowing unit, 401 indicates a housing portion, 402 indicates an opening portion, and 405 indicates an airflow production unit.

It is preferable for the interval between the secondary transfer roller 61 and the tip portion of the suction surface 212, within the first suction unit 210 that serves as a first guide portion, that holds the transfer material S, to be as narrow as possible in order to prevent the transfer material S that has been separated by the separating members 79 from becoming wrapped upon the secondary transfer roller 61. However, the transfer material grip members 64 and the separating members 79 supported within the recessed portion 63 of the secondary transfer roller 61 are positioned so as to protrude from the imaginary circle 61f extending from the contact portion 61g where the base member 61b around which the rubber sheet 61c is wrapped makes contact with the transfer belt 40 while the transfer material S is released and separated. Accordingly, an interval between the secondary transfer roller 61 and the tip portion of the suction surface 212 of the first suction unit 210 is necessary in order to prevent interference with the transfer material grip members 64 and the separating members 79.

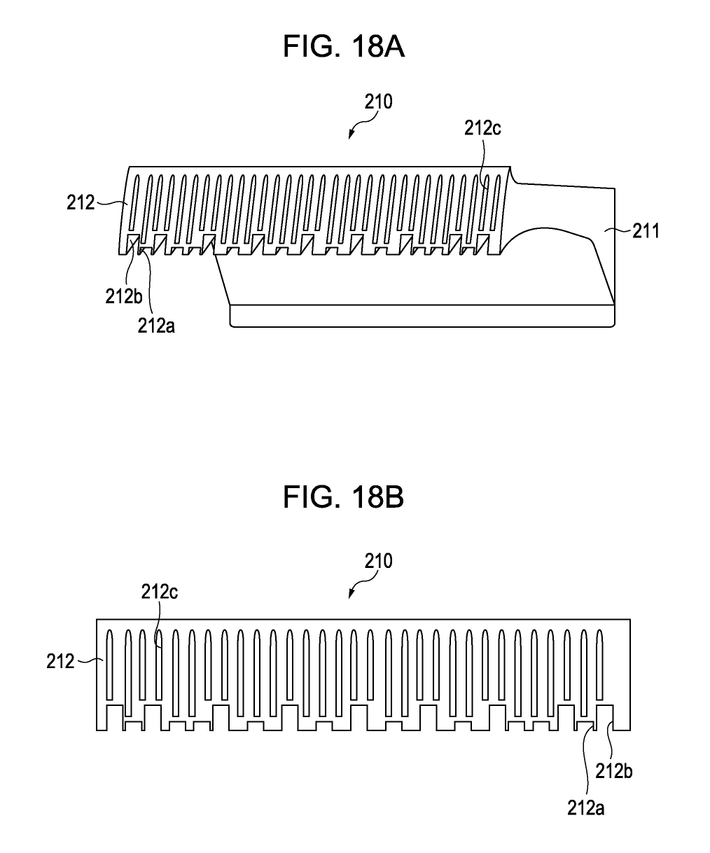

FIGS. 18A and 18B are diagrams illustrating an embodiment of the first suction unit 210 that prevents interference with the transfer material grip members 64 and the separating members 79 while reducing the interval between the secondary transfer roller 61 and the tip portion of the suction surface 212 of the first suction unit 210 to the greatest extent possible.

As shown in FIG. 18A, grip member avoidance paths 212a and separating member avoidance paths 212b are formed in a comb-tooth shape in the tip of the suction surface 212 of the first suction unit 210 on the side toward the secondary transfer roller 61 in positions corresponding to where the transfer material grip members 64 and the separating members 79 are disposed in the secondary transfer roller 61. Forming the grip member avoidance paths 212a and the separating member avoidance paths 212b in the tip of the suction surface 212 in a comb-tooth shape makes it possible to reduce the interval between the secondary transfer roller 61 and the tip of the suction surface 212, thereby making it possible to prevent the transfer material S that has been separated by the separating members 79 from wrapping upon the secondary transfer roller 61.

Air ducts 212c are formed in the comb-tooth shaped grip member avoidance paths 212a and separating member avoidance paths 212b. An attraction force from the airflow production unit 215 in the first suction unit 210 serving as the first guide portion passes along the air ducts 212c, and acts upon the grip member avoidance paths 212a and the separating member avoidance paths 212b formed in the comb-tooth shape. As a result, the transfer material S that has passed through the secondary transfer nip, been released from the transfer material grip members 64, and separated by the separating members 79 does not wrap upon the secondary transfer roller 61, but rather resists gravity, is held upon the suction surface 212, and is transported thus.

The first suction unit 210 includes the housing portion 211 in which the airflow production unit 215, which is a sirocco fan or the like, is provided; due to this airflow production unit 215, air can be discharged from a space R1 within the housing unit 211 to the exterior of the housing unit 211. The bottom surface of the housing portion 211 is the suction surface 212, in which multiple vent holes are provided across the surface. The first suction unit 210 operates the airflow production unit 215, thereby causing air to be discharged to the exterior of the housing portion 211 as indicated by a in FIG. 17, thereby generating a suction force as indicated by A in FIG. 17. As a result of this suction force, the transfer material S onto which a toner image has been transferred resists gravity and is held upon the suction surface 212. This suction force is of a degree that enables the transfer material S to be held on the suction surface 212, but is not of a degree that causes the transfer material S to resist being pressed from the secondary transfer nip, impeding the advancement of the transfer material S.

The transfer material transport device 230 is roughly configured of the housing unit 231 in which the airflow production unit 235, which is a sirocco fan or the like, is provided, the transfer material transport member 250, which is disposed around the periphery of the housing unit 231, and so on. With the transfer material transport device 230, due to the airflow production unit 235, air can be discharged from a space R2 within the housing unit 231 to the exterior of the housing unit 231.

The bottom surface of the housing portion 231 is the suction surface 232, in which multiple vent holes are provided across the surface; a suction force is produced at the suction surface 232 as indicated by B in FIG. 17 as a result of the air discharge effect caused by the airflow production unit 235, indicated by b in FIG. 17. At this time, due to the effects of the partition members 233 provided within the housing unit 231, air is discharged from the space R2 within the housing portion 231 in a comparatively uniform manner, thereby ensuring that imbalances in the suction force at the suction surface 232 do not occur from location to location.

The transfer material transport member 250 disposed in the periphery of the housing portion 231 is an endless belt in which multiple vent holes (not shown) passing through from one main surface to the other main surface are provided, and is stretched across the transfer material transport member driving roller 251, which provides a driving force to the transfer material transport member 250, and the transfer material transport member support rollers 252 and 253. The transfer material transport member 250 moves in the direction of the arrow of shown in FIG. 17 as a result of the rotation of the transfer material transport member driving roller 251, and the movement velocity thereof is approximately the same as the velocity of the image formation process. The length of the transfer material transport member 250 in the axial direction (that is, the width of the transfer material transport member 250) is set so as to be greater than the width of the transfer material having the maximum width that can be handled by the image forming apparatus.

The suction force at the suction surface 232 of the housing portion 231 also acts through the vent holes of the transfer material transport member 250, and thus the transfer material S onto which a toner image has been transferred resists gravity and is held on a transport surface P of the transfer material transport member 250; the transfer material S is also transported along the transport surface P as a result of the movement of the transfer material transport member 250 caused by the driving force of the transfer material transport member driving roller 251. The region of the transfer material transport member 250 spanning from the transfer material transport member support roller 252 to the transfer material transport member driving roller 251 is used as the transport surface P for transporting the transfer material S.

The second suction unit 270 includes the housing portion 271 in which the airflow production unit 275, which is a sirocco fan or the like, is provided; due to this airflow production unit 275, air can be discharged from a space R3 within the housing unit 271 to the exterior of the housing unit 271. The bottom surface of the housing portion 271 is the suction surface 272, in which multiple vent holes are provided across the surface; a suction force is produced as indicated by C in FIG. 17 as a result of the air discharge effect caused by the airflow production unit 275 of the second suction unit 270, indicated by c in FIG. 17. As a result of this suction force, the transfer material S onto which a toner image has been transferred resists gravity and is held upon the suction surface 272. This suction force is of a degree that enables the transfer material S to be held on the suction surface 272, but is not of a degree that causes the transfer material S to resist the pressure involved with the transport, impeding the transport of the transfer material S.

The transfer material transport unit according to this embodiment, configured of the first suction unit 210, the transfer material transport device 230, the second suction unit 270, and so on transports the transfer material with the surface of the transfer material onto which the toner image has been transferred facing downward.

The blowing unit 400 expels air into the space between the transfer belt 40 and the secondary transfer roller 61 in the vicinity of the secondary transfer nip, and using the airflow production unit 405, which is a sirocco fan or the like, feeds air into a space R4 within the housing portion 401. The opening portion 402 is provided in this housing portion 401 spanning across the axial direction of the rollers, and the air feeded into the housing portion 401 by the airflow production operations performed by the airflow production unit 405, indicated by d in FIG. 17, is expelled from this opening portion 402 as indicated by D in FIG. 17. The expulsion force of the air at this time is adjusted to a degree whereby the transfer material S onto which the toner image has been transferred resists gravity and does not sag in the downward direction, and a degree whereby the transfer material S does not flap due to the force of the air.

The entire disclosure of Japanese Patent Application No: 2009-100878, filed Apr. 17, 2009 is expressly incorporated by reference herein.

What is claimed is:

1. An image forming apparatus comprising:
an image carrier that carries an image;
a transfer roller having a transfer material grip member that moves in a circumferential direction and holds a transfer material, the transfer roller forming a transfer nip portion with the image carrier by coming into contact with each other; and
a transfer material feed portion that feeds the transfer material to the transfer nip portion,
wherein the transfer material feed velocity of the transfer material feed portion is greater than the movement velocity of the transfer material grip member when the transfer material grip member moves from the rotational center of the transfer roller in the circumferential direction of the transfer roller.

2. The image forming apparatus according to claim 1, further comprising a position detection portion that detects the movement position of the transfer material grip member in the circumferential direction of the transfer roller.

3. The image forming apparatus according to claim 2, further comprising a control unit that controls the feed timing of the transfer material from the transfer material feed unit based on movement position information of the transfer material grip member detected by the position detection portion.

4. The image forming apparatus according to claim 1, wherein the transfer roller includes an recessed portion in which the transfer material grip member is disposed and an elastic transfer material support portion that supports the transfer material by making contact with the transfer material.

5. The image forming apparatus according to claim 4, wherein the transfer material is caught by the transfer material grip member when the recessed portion is positioned at the transfer nip portion.

6. The image forming apparatus according to claim 1, further comprising a transfer material transport guide that guides the transfer material fed by the transfer material feed unit to the transfer nip portion.

7. An image forming method comprising:
carrying an image on an image carrier;
feeding a transfer material to a transfer nip portion formed by a transfer roller with the image carrier by coming into contact with each other;
grip the fed transfer material using a transfer material grip member that moves at a velocity that is slower than the feed velocity of the transfer material; and
transferring the image carried on the image carrier onto the transfer material by causing the transfer material caught by the transfer material grip member to pass through the transfer nip portion.

8. The image forming method according to claim 7, wherein the timing of the feed of the transfer material is determined based on a detection result from a detection unit that detects the movement position of the transfer material grip member in the circumferential direction of the transfer roller.
